(19) United States
(12) Patent Application Publication
(10) Pub. No.: US 2014/0352301 A1
(43) Pub. Date: Dec. 4, 2014

(54) MOTOR VEHICLE WITH A COUPLABLE WASTE HEAT RECOVERY SYSTEM

(71) Applicant: GM GLOBAL TECHNOLOGY OPERATIONS LLC, Detroit, MI (US)

(72) Inventor: Torsten Mueller, Ruesselsheim (DE)

(73) Assignee: GM GLOBAL TECHNOLOGY OPERATIONS LLC, Detroit, MI (US)

(21) Appl. No.: 14/289,289

(22) Filed: May 28, 2014

(30) Foreign Application Priority Data
May 28, 2013 (DE) 202013004907.3

(51) Int. Cl. F02B 41/00; F02B 63/04; F02B 67/06; F16H 7/02; F01K 23/06

(52) U.S. Cl. CPC F02B 41/00; F16H 7/02; F01K 23/065; F02B 67/06; F02B 63/04
USPC 60/618; 60/616

(57) ABSTRACT

A waste heat recovery system for a motor vehicle is disclosed. Waste heat generated by an internal combustion engine of a motor vehicle is recovered by a waste heat recovery system. The waste heat recovery system includes a feed heat exchanger thermally coupled to the internal combustion engine for warming up a working fluid, and a driven machine which is driven by the heated working fluid. A clutch arrangement optional couples the driven machine to a drive train or the auxiliary unit of the motor vehicle.

### CROSS REFERENCE TO RELATED APPLICATION

This application claims priority to German Patent Application No. 202013004907.3 filed May 28, 2013, which is incorporated herein by reference in its entirety.

### TECHNICAL FIELD

The technical field relates to a motor vehicle with a waste heat recovery system, which may be configured to be coupled to a drive train and/or auxiliary unit of the motor vehicle, and to a method for operating such a motor vehicle and a computer program product for carrying out such a method.

### BACKGROUND

When a working fluid is heated and expanded in a driven machine through waste heat of an internal combustion engine of a motor vehicle, the waste heat can be transposed into drive power through the driven machine which is mechanically coupled to a drive train of the motor vehicle—this can be favorable in particular in a stationary operated state of the motor vehicle. On the other side, the driven machine which is mechanically coupled to a generator of the motor vehicle can generate electric power which can be more variably employed, in particular buffer-stored—this can be correspondingly favorable in particular in non-stationary operating states of the motor vehicle.

### SUMMARY

According to an aspect of the present disclosure, a motor vehicle, in particular a passenger car includes an internal combustion engine in the form of either a spark-ignition or diesel engine, and a drive train for the mechanical coupling of the internal combustion engine to one or multiple drive wheels of the motor vehicle. The drive train may include an automatic or manual clutch coupled to a crankshaft of the internal combustion engine and/or a transmission gear set. According to an aspect of the present disclosure, the motor vehicle includes a waste heat recovery system with a feed heat exchanger, which is thermally coupled to the internal combustion engine for heating a working medium of the waste heat recovery system. In particular, the feed heat exchanger can be thermally coupled to an exhaust line of the internal combustion engine or designed in order to exchange heat with exhaust gas from the internal combustion engine flowing through the exhaust line. In an embodiment, the feed heat exchanger can be designed for the partial or complete evaporation of the working fluid pressure. To this end, the working fluid can be a working fluid with a boiling or dew point, which when heated by exhaust gas from the internal combustion engine flowing through the exhaust line partially or completely evaporates.

Downstream after the feed heat exchanger, the waste heat recovery system includes a driven machine, which is driven, continuously or optionally, by the heated fluid. The driven machine can in particular include a turbine or a screw expander or a piston machine or a combination thereof, which is designed for expanding the working medium. In particular when the feed heat exchanger is designed for evaporating the working fluid pressure and the turbine may be a steam turbine.

In an embodiment, the waste heat recovery system includes a discharge heat exchanger for cooling down the working fluid, which is arranged downstream after the driven machine. The discharge heat exchanger can in particular be thermally coupled to an air-conditioner of the motor vehicle or an air feed of the internal combustion engine or be designed in order to exchange heat with the motor vehicle surroundings. In an embodiment, the discharge heat exchanger can be designed for the partial or complete condensing of the working fluid pressure. To this end, the working fluid can be a working medium with a boiling or dew point which when cooled down by the discharge heat exchanger partially or completely condenses.

Additionally or alternatively, the waste heat recovery system can include a prime mover for, continuously or optionally, delivering of the working fluid, which is arranged upstream in front of the feed heat exchanger. The prime mover can include a pump for increasing a working fluid pressure. In an embodiment, the pump can be a feed pump, which is mechanically coupled to the internal combustion engine, or include an electric drive, which is supplied or can be supplied with electric energy through an energy storage unit of the motor vehicle.

In an embodiment, the waste heat recovery system can be designed for carrying out a Rankine cycle process, in particular a Clausius-Rankine cycle process, and more specifically an organic Clausius-Rankine cycle process (ORC, Organic Rankine Cycle), or optionally carry out such a cycle process.

According to an aspect of the present disclosure, the motor vehicle includes a clutch arrangement for selective coupling of the driven machine to the drive train. In an embodiment, the clutch arrangement is designed in order to mechanically couple the driven machine to the drive train or decouple the driven machine from the drive train. Accordingly, the driven machine is mechanically coupled to or decoupled from the drive train in particular through a switching means of a control means, which is signal-connected to the clutch arrangement and designed for the selective coupling of the driven machine to the drive train based on an operating state of the motor vehicle.

Through the optional mechanical coupling or decoupling of driven machine and drive train, the driven machine of the waste heat recovery system in an embodiment of the present disclosure can mechanically, advantageously with a high efficiency, impart the drive power to the drive train and thereby reduce the drive power to be generated by the internal combustion engine and/or increase the total drive power that is available. In this way, the fuel consumption in an embodiment can be lowered and/or the driving power increased.

Mechanical coupling can be favorable in particular in stationary operating states. Accordingly, the driven machine, in a further development, is coupled to the drive train in particular through the control or switching means, in a stationary operating state of the motor vehicle and decoupled from the drive train in an on-stationary operating state. A stationary operating state is to mean an operating state in which the internal combustion engine has an, at least substantially, constant rotational speed, and/or outputs an, at least substantially, constant torque. A non-stationary operating state is to mean an operating state, in which the internal combustion engine has a rotational speed which varies, in particular by at least 5%, and/or outputs a torque which varies, in particular by at least 10%. Because of this, in an embodiment, the fuel consumption can be lowered and/or the driving power increased.

Additionally or alternatively, the driven machine, in a further development, can be coupled to the drive train in particular through the control or switching means, in an acceleration state of the motor vehicle and decoupled from the drive train in a deceleration state. An acceleration state is to mean an operating state in which a driving speed of the motor vehicle is increased. A deceleration state is to mean an operating state in which a driving speed of the motor vehicle is reduced. Because of this, too, in an embodiment, the fuel consumption can be lowered and/or the driving power increased.

Additionally or alternatively, in a further development, the driven machine can be coupled to the drive train through the control and switching means in a warming up state of the motor vehicle and decoupled from the drive train in a warmed-up operating state. A warming-up state is to mean an operating state in which the temperature of the internal combustion engine is increased to operating temperature. A warmed-up operating state is to mean an operating state in which the internal combustion engine is at operating temperature. Because of this, too, in an embodiment the fuel consumption can be lowered and/or the driving power increased. It can be favorable in particular to shut down the waste heat recovery system during a warming-up of the internal combustion engine, decoupling the internal combustion engine from the drive train for this purpose.

In an embodiment, the driven machine of the present disclosure can be permanently coupled to an auxiliary unit of the motor vehicle, in particular a generator, which is configured to charge an energy storage unit of the motor vehicle and/or for supplying one or multiple electrical consumers, in particular electric drives, electric heating devices or the like, or charges or supplies these electrical consumers. When the driven machine is also mechanically coupled to the drive train, a power split takes place in an embodiment. When decoupled from the drive train the driven machine exclusively drives the auxiliary unit. In this way, in non-stationary operating states, in a deceleration state or in a warming-up state, waste heat from the internal combustion engine can be transposed through the waste heat recovery system exclusively to the auxiliary unit, in particular a generator. This can be energetically more favorable, in particular have a better efficiency than a mechanical transposition to the drive train.

Equally, the driven machine in an embodiment of the present disclosure can be optionally also mechanically coupled to the auxiliary unit, for example in non-stationary operating states, in a deceleration state or warming-up state coupled to the auxiliary unit and decoupled in a stationary state or acceleration state in order to exclusively transpose the waste heat from the internal combustion engine through the waste heat recovery system to the drive train. An optional mechanical coupling of the driven machine to the auxiliary unit can be provided, additionally or alternatively, to a mechanical coupling of the driven machine to the drive train. Permanent mechanical coupling of the auxiliary unit or of the drive train to the driven machine in an embodiment can be easier, more reliable and/or cheaper. Optional mechanical coupling of the auxiliary unit, as well as of the drive train to the driven machine can increase the variability, and thus lower the fuel consumption even further and/or increase the driving power even further.

In an embodiment, the clutch arrangement includes a traction means, a drive train pulley which is operationally connected to the traction means for the mechanical coupling of the drive train, an auxiliary unit pulley which is operationally connected to the traction means for the mechanical coupling of the auxiliary unit and a driven machine pulley which is operationally connected to the traction means for the mechanical coupling of the driven machine. By way of a traction means, vibrations and/or tolerances can be advantageously compensated in an embodiment.

The traction means can be a ribbed belt with one or multiple in particular wedge-shaped longitudinal ribs, in particular a V-belt or so-called poly-V-belt, which is operationally connected in a frictionally joined manner to the drive train pulley, auxiliary unit pulley and driven machine pulley. Equally, the traction means can include, in particular be a ribbed belt with multiple, in particular wedge-shaped transverse ribs which is operationally connected in a positively joined manner to the drive train pulley, auxiliary unit pulley and driven machine pulley. The traction means can equally include a chain, a thrust link conveyor or the like. Through these mechanical traction means in an embodiment, a high mechanical efficiency can be achieved.

For the optional coupling of the driven machine to the drive train, the coupling arrangement in an embodiment includes an electrically, pneumatically and/or hydraulically switchable clutch for the optional coupling of the drive train pulley to the drive train, which is commanded or actuated by the switching means of the control means. The clutch can in particular optionally disconnect the drive train and the drive train pulley or mechanically couple these in frictionally joined and/or positively joined manner.

For the optional coupling of the driven machine to the auxiliary unit, the clutch arrangement in an embodiment can additionally or alternatively include an in particular electrically, pneumatically and/or hydraulically switchable clutch for the optional coupling of the auxiliary unit pulley to the auxiliary unit, which in a further development is commanded or actuated by the switching means of the control means. The clutch can optionally disconnect a driveshaft of the auxiliary unit and the auxiliary unit pulley or couple these mechanically, in particular in a frictionally joined and/or positively joined manner.

For the optional coupling of the driven machine to the drive train and/or the auxiliary unit, the clutch arrangement in an embodiment can additionally or alternatively include an electrically, pneumatically and/or hydraulically switchable clutch for the optional coupling of the driven machine pulley to the driven machine, which is commanded or actuated by the switching means of the control means. The clutch can disconnect an output shaft of the driven machine and the driven machine pulley or couple these mechanically in a frictionally joined and/or positively joined manner.

In this way, the drive train pulley, auxiliary unit pulley or driven machine pulley can advantageously remain operationally connected to the traction means. Mechanical coupling is in general to mean a mechanically joined connection, for example in a frictionally and positively joined connection, which is designed for transmitting rotational moments in one or both directions of rotation. In a further development, the driven machine pulley can be mechanically coupled to the driven machine via a free wheel, so that a higher rotational speed of the drive train even with mechanically coupled driven machine has no or only a limited reactive effect on the latter. In this way, the waste heat recovery system or its operation can be optimized.

In an embodiment, the clutch arrangement can be designed for the optional mechanical coupling of the driven machine to a crankshaft of the drive train, in a further development through the traction means and the switchable clutch between a drive train pulley that is operationally connected to the traction means and the crankshaft of the internal combustion engine, which is thus equally part of the internal combustion engine and of the drive train or the link between these two.

A control or switching means in terms of the present disclosure can be designed as hardware and/or software, in particular include a digital processing unit, in particular microprocessor unit (CPU) which is preferably data or signal-connected to a memory and/or bus system and/or include one or multiple programs or program modules. The CPU can be designed in order to execute commands which are implemented as a program stored in a storage system, to capture input signals from a data bus and/or emit output signals to a data bus. A storage system can include multiple, different storage media, optical, magnetic, solid-state and/or other non-volatile media. The program can be designed such that it embodies or is capable to carry out the methods described here, so that the CPU can execute the steps of such methods, and thereby control the clutch arrangement. In an embodiment, the control means is also designed in order to control, and regulate the internal combustion engine and/or the waste heat recovery system, its working fluid flow. Accordingly, the control or switching means in an embodiment can include, in particular be an engine control of the motor vehicle.

### BRIEF DESCRIPTION OF THE DRAWINGS

The present disclosure will hereinafter be described in conjunction with the following drawing figures, wherein like numerals denote like elements, and:

FIG. 1 schematically represents a portion of a motor vehicle according to an embodiment of the present disclosure; and

FIG. 2 shows a method according to an embodiment of the present disclosure for operating the motor vehicle of FIG. 1.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

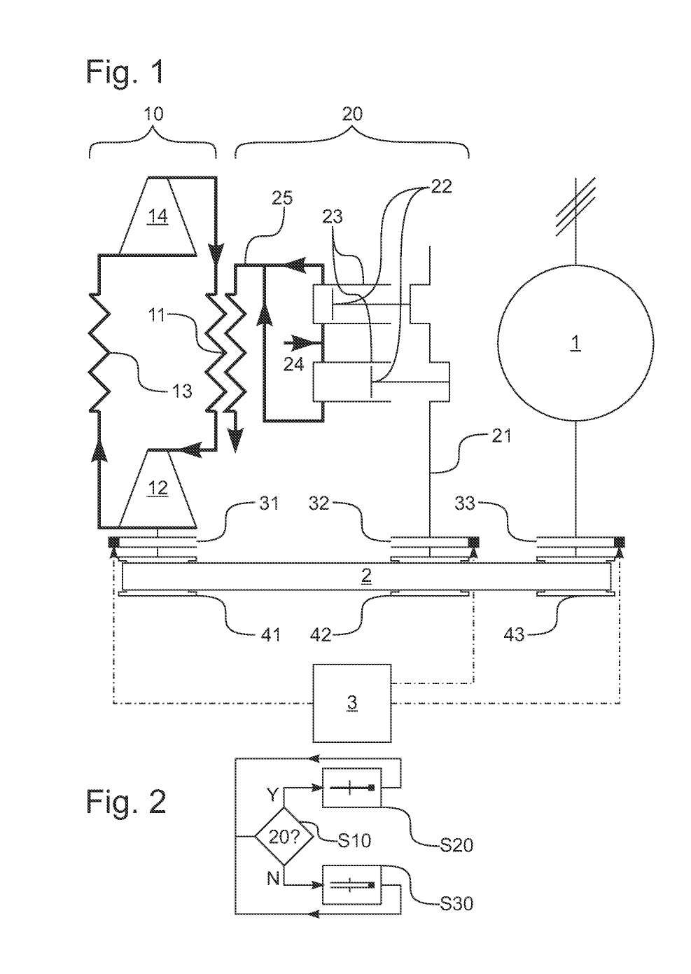

FIG. 1 shows a part of a motor vehicle according to an embodiment of the present disclosure with an internal combustion engine 20. In FIG. 1, a portion of the engine 20 is indicated by a crankshaft 21, two pistons 22 rotating the latter, which operate in cylinders 23, an air-fuel feed line 24 (here, air and fuel can also be introduced separately into the combustion chamber) and an exhaust line 25. The crankshaft 21 simultaneously represents a part of a drive train of the motor vehicle for coupling the internal combustion engine 20 to two drive wheels of the motor vehicle in a manner which is known per se (not shown). It should be understood that the engine 20 may include additional pistons and cylinders operably coupled to the crankshaft 21.

The motor vehicle, furthermore, includes an auxiliary unit in the form of a generator 1, which is designed in order to charge an energy storage unit of the motor vehicle, for example a vehicle battery, and/or to supply electrical consumers of the motor vehicle (not shown).

The motor vehicle, furthermore, includes a waste heat recovery system 10 for carrying out a Rankine cycle process. The waste heat recovery system 10 includes a feed heat exchanger 11, which is thermally coupled to the exhaust line 25 of the internal combustion engine 20 and transfers heat from the exhaust gas from the cylinders 23 flowing through the exhaust line 25 to a working fluid, which is heated and evaporates. The heat supply can be switchably configured via a gate or/and valve system.

Through this vapor or the heated working fluid, a driven machine in the form of an expansion machine 12 is driven, in which the vapor expands. Downstream after the expansion machine 12, a discharge heat exchanger 13 for cooling down the vapor is arranged, in which the working fluid condenses. Downstream after the discharge heat exchanger 13 and upstream in front of the feed heat exchanger 11, a prime mover in the form of a pump 14 for delivering the working fluid in a flow direction indicated by arrows in FIG. 1 is arranged, this increases the working fluid pressure.

The motor vehicle, furthermore, includes a clutch arrangement for the optional coupling of the expansion machine 12 to the crankshaft 21. Additionally or alternatively, the clutch arrangement can be designed for the optional coupling of the expansion machine 12 to the generator 1. These different embodiments are shown jointly in FIG. 1 for a more compact representation. The clutch arrangement includes a traction means in the form of a poly-V-belt 2, with which a driven machine pulley 41, a drive train pulley 42 and an auxiliary unit pulley 43 are operationally connected in a frictionally joined manner. In an embodiment, the clutch arrangement includes a switchable clutch 31 for the optional coupling of the drive train pulley 42 to the crankshaft 21.

Additionally, the clutch arrangement can includes a switchable clutch 33 for the optional coupling of the auxiliary unit pulley 43 to the generator 1. Equally, in a modification which is not shown, the generator 1 can also be coupled to the auxiliary unit pulley 43 permanently or free of a clutch, the clutch 33 which is jointly shown in FIG. 1 for a more compact representation has to be imagined to be not there.

Additionally or alternatively, the clutch arrangement can includes a switchable clutch 31 for the optional coupling of the driven machine pulley 41 to the turbine 12. Equally, in a modification which is not shown, the turbine 12 can also be coupled to the driven machine pulley 41 permanently or free of a clutch, the clutch 31 which is jointly shown in FIG. 1 for a more compact representation has to be imagined to be not there in this modification. Between the expansion machine 12 and the driven machine pulley 41, a free wheel (not shown) is arranged, which locks or couples the turbine 12 to the driven machine pulley 41 permanently or free of a clutch in the event that an output rotational speed of the expansion machine 12 taking into account the transmission ratio between driven machine pulley 41 and drive train pulley 42 is greater than a rotational speed of the crankshaft 21, and in the other case, opens or disconnects expansion machine 12 and driven machine pulley 41. This, too, is described as a clutch-free or permanent coupling of turbine 12 and driven machine pulley 41.

In a further modification which is not shown, the crankshaft 21 can also be coupled to the drive train pulley 42 permanently or in a clutch-free manner, the clutch 32 which is shown jointly in FIG. 1 for a more compact representation must be imagined to be absent in this modification. In this case, the clutch 31 and/or 33 shown in FIG. 1 is preferentially provided.

Through the switchable clutches 31, 32 and/or 33, the expansion machine 12 can be optionally mechanically coupled to or decoupled from the crankshaft 21 and/or the generator 1.

To this end, the motor vehicle furthermore includes a controller in the form of an engine controller 3 with a switch in the form of a suitably designed part or program of the engine controller 3. The engine controller 3 is signal-connected with electromagnetic, electro-motoric, hydraulic or pneumatic actuators of the clutches 31, 32 and/or 33, which are indicated in FIG. 1 by filled-out rectangles, as is indicated in FIG. 1 by dash-dotted arrows. The engine controller 3 and/or its switch are designed for carrying out a method according to an embodiment of the present disclosure for operating the motor vehicle of FIG. 1, which is explained in more detail in the following with reference to FIG. 2.

In a step S10, a query of an operating state of the motor vehicle made to determine if the motor vehicle or its internal combustion engine 20 is in a stationary state or an acceleration state or not, i.e. in a non-stationary state or deceleration state or warming-up state.

If it is determined in step S10 that the motor vehicle or its internal combustion engine 20 is in a stationary state or an acceleration state (S10=“Y”), the method or the engine controller 3 proceeds with a step S20, in which the turbine 12 is mechanically coupled to the crankshaft 21. To this end, in an embodiment, in which only a clutch 32 is provided, the clutch 32 is closed in step S20. In a modification, in which additionally or alternatively the clutch 31 is provided, this clutch 31 is closed in step S20. In a modification, in which additionally or alternatively the clutch 33 is provided, this clutch 33 can be opened in an embodiment in step S20 in order to stop a power split to the generator 1. In an alternative embodiment, this clutch 33 can be closed in step S20 in order to split an output power of the turbine 12 over crankshaft 21 and generator 1.

If it is determined in step S10 that the vehicle or its internal combustion engine 20 is in a non-stationary deceleration or warming-up state (S10=“N”), the method or the engine control 3 proceeds with a step S30 in which turbine 12 is decoupled from the crankshaft 21. To this end, in an embodiment, in which only the clutch 32 is provided, this clutch 32 is opened in step S30. In a modification, in which additionally or alternatively the clutch 31 is provided, this clutch 31 is opened in step S30. In a modification, in which additionally or alternatively the clutch 33 is provided, this clutch 33 in an embodiment can be opened in step S30 in order to decouple also the generator from the turbine 12. In an alternative embodiment, this clutch 33 can be closed in step S30 in order to direct output power of the turbine 12 to the generator 1.

Following step S20 or S30, the method or the engine control 3 returns to step S10.

Although in the preceding description exemplary embodiments were explained it is pointed out that a multiplicity of modifications is possible. In particular, as explained above, various embodiments are jointly represented in FIG. 1 for a more compact representation, wherein in an embodiment the clutches 31, 33 can be omitted or should be imagined to be absent, in another embodiment, the clutch 31 or 33 can be omitted or imagined to be absent in order to optionally couple the expansion machine 12 to the crankshaft 21 or decouple the expansion machine 12 from the crankshaft. It is additionally pointed out that the exemplary embodiments are merely examples which are not intended to restrict the scope of protection, the applications and the construction in any way.

The preceding description rather provides the person skilled in the art with a guideline for implementing at least one exemplary embodiment, wherein various changes, in particular with respect to the function and arrangement of the described constituent parts can be carried out without leaving the scope of protection, as is obtained from the claims and feature combinations equivalent to these. Thus, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-12. (canceled)

13. A waste heat recovery system for motor vehicle having an internal combustion engine coupled to a drive train and an auxiliary unit, the waste heat recovery system comprising:
a feed heat exchanger configured to be thermally coupled with the internal combustion engine for heating a working fluid;
a driven machine driven by the heated working fluid; and
a clutch arrangement configured to selectively couple the driven machine with at least one of the drive train and the auxiliary unit.

14. The waste heat recovery system according to claim 13 further comprising a discharge heat exchanger arranged downstream from the driven member for cooling down the working fluid.

15. The waste heat recovery system according to claim 13 further comprising a prime mover arranged downstream of the discharge heat exchange and upstream of the feed heat exchanger for pressurizing the working fluid.

16. The waste heat recovery system according to claim 15 wherein the system is configured to designed carry out a Rankine cycle process

17. The waste heat recovery system according to the claim 15, wherein the feed heat exchanger is designed for evaporating the working fluid pressure, wherein the driven machine comprises an expansion machine for expanding the working fluid, wherein the prime mover comprises a pump for increasing a working fluid pressure, and wherein the discharge heat exchanger is designed for condensing the working fluid pressure.

18. The waste heat recovery system of claim 17 wherein the feed heat exchanger is thermally coupled to an exhaust line of the internal combustion engine.

19. The waste heat recovery system according to claim 13, wherein the clutch arrangement comprises:
a first pulley on the drive train;
a second pulley on the auxiliary unit;
a third pulley on the driven machine;
a drive belt operationally connecting the first, second and third pulleys; and
a switchable clutch for selectively coupling at least one of the first pulley to the drive train, the second pulley to the auxiliary unit and the third pulley to the driven machines.

20. The waste heat recovery system according to claim 19 wherein the third pulley is coupled to the driven machine with a free wheel.

21. The waste heat recovery system according to claim 19, wherein the drive belt comprises a ribbed belt having at least one longitudinal rib and is operationally connected in a frictionally joined manner to the first, second and third pulleys.

22. The waste heat recovery system according to claim 21 wherein the third pulley is coupled to the driven machine with a free wheel.

23. A motor vehicle of the type having an internal combustion engine, a drive train for coupling the internal combustion engine to at least one drive wheel, an auxiliary unit, and a waste heat recovery system comprising:
a feed heat exchanger thermally coupled an exhaust line of the internal combustion engine for heating a working fluid;
a driven machine driven by the heated working fluid; and
a clutch arrangement configured to selectively couple the driven machine with at least one of the drive train and the auxiliary unit.

24. The motor vehicle according to claim 23, wherein the drive train comprises a crankshaft, and wherein the clutch arrangement is configured to selectively couple the driven machine to said crankshaft.

25. The motor vehicle according to claim 23 wherein the auxiliary unit comprises a generator.

26. The motor vehicle according to claim 23 further comprising a controller in communication with the clutch arrangement and having a switch for the selectively coupling of the driven machine and at least one of the drive train and the auxiliary unit on the basis of an operating state of the motor vehicle.

27. The motor vehicle of claim 26 wherein the driven machine is coupled to the drive train when the operational state of the motor vehicle is in a stationary state or in an acceleration state, and the driven machine is decoupled from the drive train when the motor vehicle is in a non-stationary state, or in a deceleration state or in a warming up-state.

28. The motor vehicle of claim 26 wherein the driven machine is coupled to the auxiliary unit when the operational state of the motor vehicle is in a stationary state or in an acceleration state, and the driven machine is decoupled from the auxiliary unit when the motor vehicle is in a non-stationary state, or in a deceleration state or in a warming up-state.
